(19) United States
(12) Patent Application Publication
(10) Pub. No.: US 2008/0006775 A1
(43) Pub. Date: Jan. 10, 2008

(54) INFRARED GAS DETECTION SYSTEMS AND METHODS

(76) Inventors: Jose I. Arno, Brookfield, CT (US); Paul J. Marganski, Seymour, CT (US); Robert Hillas, Princeton, NJ (US); Steven M. Lurcott, Sherman, CT (US); Glenn M. Tom, Bloomington, MN (US)

Correspondence Address: INTELLECTUAL PROPERTY / TECHNOLOGY LAW, PO BOX 14329, RESEARCH TRIANGLE PARK, NC, 27709, US

(21) Appl. No.: 11/767,382

(22) Filed: Jun. 22, 2007

Related U.S. Application Data
(60) Provisional application No. 60/805,591, filed on Jun. 22, 2006.

(51) Int. Cl. G01N 21/00

(52) U.S. Cl. 250/338.5; 250/338.1; 250/343

(57) ABSTRACT

Thermopile-based detection and monitoring/control systems are described, in applications such as inferring concentration of a multicomponent gas by sensing a tracer gas therein, utilizing fiber optic cables to provide multiple sensing paths in a cell, utilizing a modulated IR source switched in on/off cycles, verifying chemical reagent identities, and sensing of effluent following discharge from a contamination removal 8 element or cold trap. A thermopile infrared (TPIR) detector of highly compact character is described for such applications, and permits monitoring of species that may be problematic or otherwise deleterious in such environments. In one implementation, light source modulation and signal processing techniques are employed to improve signal to noise ratio and minimize calibration and complexity of the TPIR detector.

### STATEMENT OF RELATED APPLICATION(S)

This application claims benefit of U.S. Provisional Patent Application No. 60/805,591 filed on Jun. 22, 2006.

### FIELD OF THE INVENTION

The present invention relates to infrared detection of fluids, and to systems and processes therefor.

### DESCRIPTION OF THE RELATED ART

The detection and monitoring of fluids is necessary in a wide variety of circumstances. Examples include situations in which a gas may be toxic or hazardous in a specific environment, e.g., to organisms or structural articles or materials in such environment. Further, detection and monitoring are useful in determining integrity of containment structures that are used to hold fluids, to assess whether leakage or degradation of the containment structure is or has been occurring.

Additional applications in which gas detection and monitoring are utilized include environmental monitoring, for verification of an unpolluted character of a local atmospheric environment, or to monitor the operation and efficiency of pollution abatement equipment and systems.

Other applications in which gas detection and monitoring are utilized include systems in which a change of physical state occurs, as a result of which a gas or vapor phase composition is altered.

In these and many other applications involving gas detection and monitoring, it is desirable that the detector be as compact and efficient as possible, and be capable of extended operation with minimum downtime and deterioration of detection capability. Further, it is desirable that such detectors be as simple in construction and operation, and as economical to use, as possible. Detectors employed for fluid monitoring should additionally be highly selective in character for the target gas species.

One recurrent problem with detectors utilized for monitoring of gases is that the gases may not be very interactive with the sensing element or medium, as a result of which it is difficult to monitor the target gas species.

### SUMMARY OF THE INVENTION

The present invention relates to infrared detection of gases, and to systems and processes for such detection.

In one aspect, the invention relates to a gas monitoring system including a TPIR detector, operatively arranged for a sensing operation comprising any of:
(a) sensing of a multicomponent gas to determine a concentration of a component therein other than a component detectible by the TPIR detector;
(b) sensing of gas in a cell having a multiplicity of zones therein defined using fiber optic cables to provide a multiplicity of gas sensing paths within the cell;
(c) sensing with a modulated infrared radiation source switched in on/off cycles;
(d) sensing of a fluid sampled from a supply package to verify identity of fluid contained within said supply package;
(e) sensing of effluent from an environment after treatment to remove contaminants therefrom; and
(f) sensing of effluent from a cold trap system to determine when a cold trap has been loaded and requires regeneration.

In another aspect, the invention relates to a gas sensing process comprising use of the foregoing system.

In another aspect, the invention relates to a method of gas sensing comprising any of:
(a) sensing of a multicomponent gas to determine a concentration of a component therein other than a component detectible by the TPIR detector;
(b) sensing of gas in a cell having a multiplicity of zones therein defined using fiber optic cables to provide a multiplicity of gas sensing paths within the cell;
(c) sensing with a modulated infrared radiation source switched in on/off cycles;
(d) sensing of a fluid for verification of identity thereof in a supply package containing such fluid;
(e) sensing of effluent from an environment after treatment to remove contaminants therefrom; and
(f) sensing of effluent from a cold trap system to determine when a cold trap has been loaded and requires regeneration,
   wherein the sensing comprises thermopile detection of radiation in an infrared spectral regime

Other aspects, features and embodiments of the invention will be more fully apparent from the ensuing disclosure and appended claims.

### BRIEF DESCRIPTION OF THE DRAWINGS

FIG. 1 is a schematic representation of a thermopile detector system, such as may be utilized in the practice of the present invention, in various embodiments thereof.

FIG. 2 is a prospective view of a refrigerator featuring a TPIR detector for determining leakage of refrigerant gas from a refrigeration circuit and associated components.

FIG. 3 is a schematic representation of a food treatment installation, utilizing a TPIR detector, according to one embodiment of the invention.

FIG. 4 is a multi-component gas blending and utilization system, featuring the use of a TPIR detector to determine concentration of a major component of a blended mixture.

FIG. 5 is a schematic representation of a TPIR detector according to one embodiment of the invention.

FIG. 6 is a schematic representation of a thermopile detector according to another embodiment of the invention.

FIG. 7 is a schematic representation of a TPIR detector system in which the radiation passed through the sample cell is modulated by a chopper device or an on/off switch.

FIG. 8 is a schematic representation of a liner-based liquid transport and dispensing package, featuring the use of a TPIR detector for positive liquid identification, to avoid any misconnect of the container with a dispense assembly.

FIG. 9 is a schematic representation of a mini-environment that is monitored by use of a TPIR detector, in conjunction with the use of catalyst beds for removal of contaminant species from the gas discharged from the mini-environment.

FIG. 10 is a schematic representation of a cold trap system, wherein two cold traps are arranged for alternating operation, as monitored by a TPIR detector, to effect the switching of the respective vessels between on-stream and off-stream states.

### DETAILED DESCRIPTION OF THE INVENTION, AND PREFERRED EMBODIMENTS THEREOF

The present invention provides an infrared thermopile detector system useful for monitoring and control applications, and methods of monitoring and/or controlling environments, processes and systems using infrared thermopile sensing of conditions in and/or affecting same.

U.S. Pat. No. 6,617,175 entitled “Infrared thermopile detector system for semiconductor process monitoring and control,” which is commonly assigned with the owner of the instant application, is hereby incorporated by reference for all purposes.

The operation of the infrared detection system of the invention is based on the fact that most infrared energy-absorbing molecules absorb infrared radiation at discrete energy levels, so that when a gas, liquid or solid composition is exposed to a broad wavelength infrared radiation, the infrared energy-absorbing component(s) of that composition will absorb a portion of the IR light at very specific wavelengths. This phenomenon in turn enables the comparison of the energy spectrum with and without the IR-absorbing component(s), to obtain an absorption profile with patterns that can be used to identify materials in a composition. Additionally, the concentration of a material in the composition can be directly measured by the amount of light that is absorbed by the material.

The infrared detection system of the invention reflects an advance over the use of spectrometric dispersive IR analyzers that use grading techniques or prisms to break IR radiation into its individual wavelengths, pass a selective wavelength through a gas cell from a movable slit aperture, and correlate the slit aperture position with the IR energy level to produce energy versus absorbance relations. The principal drawbacks of such dispersive spectrometers are the use of movable parts that are prone to failure, the cost of the spectrometer apparatus due to the number of components, and the slow collection rates that are characteristic of dispersive spectrometer operation.

The infrared detection system of the invention also reflects an advance over the use of Fourier transform IR (FT-IR) spectrometers, which like dispersive spectrometers, also use broad energy IR sources. The originally generated IR beam is split into two beams and an interference pattern is created by sending one of the two beams in and out-of-phase, using a movable mirror. A laser beam is used to monitor the location of the movable mirror at all times. After the dual beam is sent to a sample, a sensor component of the spectrometer device receives the convoluted infrared wave pattern together with the laser-positioning beam. That information is then sent to a computer and deconvoluted using a Fourier transform algorithm. The energy versus mirror displacement data is thereby converted into energy versus absorbance relationships. The drawbacks of FT-IR spectrometers include their complexity and substantial cost.

Infrared thermopile detectors employed in the practice of the present invention have major advantages over dispersive and FT-IR spectrometers in terms of (i) low cost, (ii) simplicity of design (no movable parts), (iii) fast response.

A preferred thermopile-based infrared monitoring system of the invention comprises an infrared (IR) light source, a gas cell and a thermopile detector. The gas cell is a gas sample monitoring region, which in the broad practice of the invention may comprise any suitable compartment, passageway or chamber in which the gas to be monitored is subjected to passage of IR light through the gas for the purpose of using its IR absorbance-determined output to generate control signal(s) for fluid monitoring and control. The monitoring system in preferred practice utilizes mirror(s) and/or lenses to collimate and direct the IR light. The thermopile detector generates small voltages when exposed to IR light (or heat in the IR spectral regime). The output signal of the thermopile detector is proportional to the incident radiation on the detector.

Thermopile detectors employed in the preferred practice of the present invention have a multiple array of elements in each detector unit. For instance, in a dual element detector, one of the thermopile detector elements can be used as a reference, sensing IR light in a range in which substantially no absorption occurs (e.g., wavelength of 4.00±0.02 μm). The second thermopile detector element is coated with a filter that senses IR energy in the spectral range of interest (such spectral range depending on the particular material to be monitored). Comparison of the differences in the voltages generated by the reference thermopile detector element and those generated by the thermopile detector active element(s) provides a concentration measurement. Detectors with up to 4 thermopile detector element arrays are commercially available. For example, in a 4-element detector unit, one detector element is employed as a reference and the remaining 3 detector elements are utilized for measurements in different spectral regions.

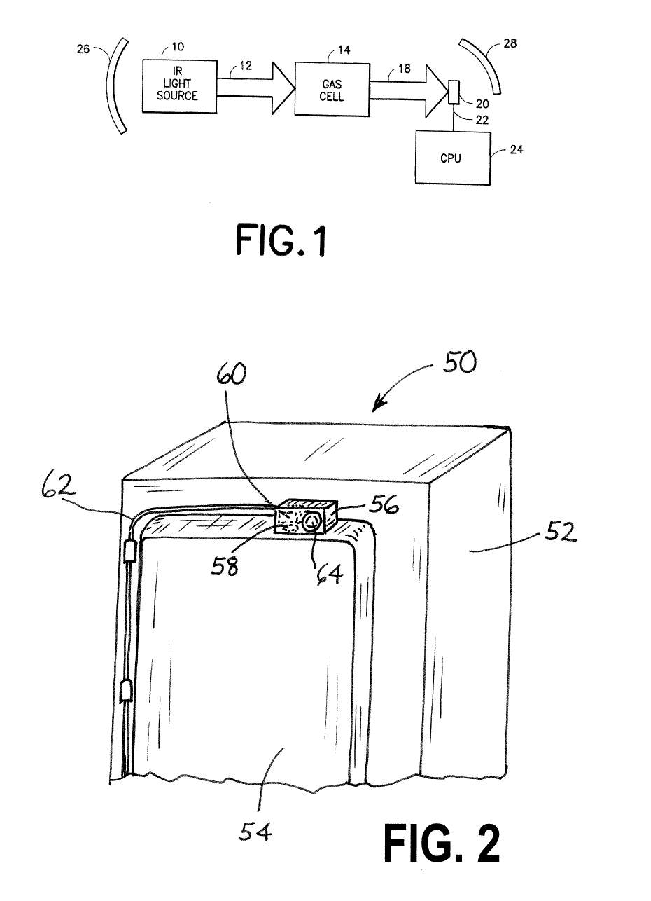

A schematic representation of a thermopile-based detector system illustrating its operation is shown in FIG. 1, wherein an IR source 10, such as an IR lamp, generates a broad (extended spectral range of IR wavelengths) infrared beam 12. The IR beam 12 is impinged on the gas cell 14 having an interior volume 16 in which the gas to be monitored is present for analysis. The gas cell may be a compartment, cross-sectional region or portion of a gas flow conduit in the process system. Alternatively, a slip-stream (side stream) of a gas flow may be extracted from a flow conduit or piping for the gas monitoring operation.

After passage through and interaction with the gas in the interior volume 16 of the gas cell 14, IR radiation 18 emitting from the gas cell 14 after traversing same then impinges on thermopile detector 20. The thermopile detector unit may utilize embedded IR filter(s) allowing the radiation of specific IR wavelengths to pass through the (respective) filter(s), in consequence of which the thermopile detector determines the radiation intensity and produces an output voltage signal for each element of the detector. The voltage output of the thermopile detector unit shown in FIG. 1 is passed by means of signal transmission line 22 to central processing unit 24, e.g., a personal computer, microprocessor device, or other computational means, wherein voltage signal(s) generated by the detector element(s) are algorithmically manipulated to produce an output concentration value for each of the gas component(s) of interest.

The thermopile-based analyzer system illustratively shown in FIG. 1 includes mirrors 26 and 28 for focusing the IR radiation. Mirrors can also be used to multipass the infrared beam more than one time across the interior volume 16 in order to enhance the detection limit. The infrared light source 10 in the FIG. 1 system may be of any suitable type, as for example a PerkinElmer IRL 715 infrared lamp providing IR radiation in a spectrum of from about 2 to about 4.6 μm wavelength. The thermopile detector 20 likewise may be of any suitable type, as for example a PerkinElmer TPS 3xx single detector, a PerkinElmer TPS 5xx single detector, a PerkinElmer 2534 dual detector, or a PerkinElmer 4339 quad detector, as necessary or desirable in a given end use application of the invention. Such illustrative infrared light source 10 and thermopile detector 20 elements are commercially available from PerkinElmer Optoelectronics (Wiesbaden, Germany).

Thermopile detector elements in one preferred embodiment of the invention have a response time in the 10-40 millisecond (ms) range. Thermopile detector units employed in the practice of the invention are advantageously configured with detector absorber areas for collecting the infrared light to be measured, with thermal elements positioned below the absorber area, so that infrared light incident on the absorber area heats the absorber area and generates a voltage at the output leads, as a DC voltage providing a direct measure of the incident radiation power. Such thermopile detector unit advantageously employs a gas-specific infrared radiation band pass filter in front of the thermopile detector element, so that the decrease in output voltage generated by such thermopile is directly related to the amount of infrared absorption by the corresponding gas. The thermopile detector unit as mentioned may include a multiplicity of absorber areas, including reference (unfiltered) absorber and gas-filtered absorber regions, with the latter filters being gas-specific for sensing of the gases or gas components of interest.

In accordance with the invention, thermopile IR detector units are usefully employed in a variety of applications, as described more fully below.

In one illustrative embodiment of the invention, the thermopile IR detector unit is employed as a gas monitoring unit, e.g., as an in-line monitor installed in a gas flow line. In such application, the inherent stability of the thermopile detector unit facilitates accurate concentration measurements. Further, the signal generated by the thermopile detector unit enables feedback control arrangements to be implemented, e.g., involving feedback from the thermopile detector unit to a mass flow controller to responsively increase or decrease delivery rates of a gas being flowed to a process or other location of use, so as to maintain constant concentration, volumetric flow rate, gas flux, etc., in the specific gas delivery application.

In other illustrative embodiments of the invention, the thermopile IR detector unit is employed as a gas monitoring unit to monitor presence or incursion of gas in an environment susceptible to such presence or incursion. The environment may be an air-containing environment, such as an ambient outdoor environment, and indoors environment in a manufacturing facility, residential building, sports arena, airport complex, or the like. In a specific implementation, the thermopile IR detector can be utilized for monitoring to determine the presence of pathogens or other deleterious agents, as an anti-terrorism and/or public safety implementation of the invention.

The foregoing discussion is illustrative, and it will be recognized that a wide variety of applications and implementations of the invention are possible, with such utility being more fully apparent from the ensuing disclosure and specifically disclosed embodiments of the invention.

It will be recognized that in various applications a multiplicity of thermopile detector units may be utilized for monitoring and detection, as part of an integrated sensing network, and that the IR thermopile detector units may be integrated with control circuitry involving one or multiple computers, processors, cycle-time program controllers, etc. Further, it will be recognized that the thermopile detectors can be arranged to produce output signals, e.g., voltage output signals, that may be utilized with other signal generation and transmission/control devices and interfaces, to effectuate the monitoring and control functions needed in a specific implementation of the invention.

For example, the thermopile detector output signal may be converted to a radio frequency signal transmitted by a radio frequency transponder that is transmitted to a radio frequency receiver in an integrated wireless network for monitoring and control purposes.

The output, e.g., voltage-based output, of the thermopile detector may be converted to other signal forms, or even reconverted to an infrared control signal for wireless communication to a central processing unit or other computational or control unit.

The invention in one implementation is directed to monitoring of global warming gases.

Global warming gases such as fluorocarbons, chlorofluorocarbons, halocarbons, sulfur halide gases, nitrogen trifluoride, sulfur hexafluoride, and refrigerant fluid are a source of significant worldwide concern. Such gases have a large infrared absorption cross section and are slow to degrade in an atmospheric or stratospheric environment. Continuing efforts are being made to control emissions of such gases in order to minimize their impact on the environment.

Halocarbon and sulfur halide gases are widely used and/or generated in the semiconductor manufacturing industry, as well as in other commercial applications, including, for example, use as surface protectants during metal molding processes (SF₆, C₂F₆), use as switching and insulation media in electrical power equipment (SF₆), use as working fluids in refrigeration systems (numerous halocarbons), and use as fumigants in the treatment of food products (methyl bromide).

The present invention in various embodiments uses thermopile infrared (TPIR) detectors for the detection of global warming gases in various applications, including applications other than semiconductor manufacturing.

The use of a TPIR photometric detector for detection of global warming gases is advantageous, due to the strong adsorption of infrared radiation by global warming gases. Such gases are readily reproducibly detectable by infrared detectors, and a TPIR photometer detector provides an effective device for monitoring the presence and/or concentration of such gases. TPIR photometers enable sensing of global warming gases over a wide range of concentrations. In addition, the IR filtering capability of the TPIR allows selectivity by blocking all radiation frequencies with the exception of the specific region of IR absorbance corresponding to the global warming gas being analyzed.

By way of specific illustrative example, a leaky refrigerant system can compromise refrigeration performance and create regulatory and compliance issues with respect to legislative constraints on global warming gases. A TPIR detector can be deployed to monitor leakage of refrigerant, so that maintenance or other remedial action is taken.

FIG. 2 is a perspective view of a refrigerator utilizing a TPIR detector for monitoring leakage of refrigerant. The refrigerator 50 includes a main refrigerated enclosure 52 of conventional type, on the back of which are mounted evaporator, compressor and condenser components within the panel 54, and associated refrigerant flow circuitry. Disposed on panel 54, as illustrated, is a TPIR detector assembly 56, which comprises a housing defining an interior volume which is in fluid flow communication with the interior volume of panel 54 through fluid communication opening 58 on the top surface of panel 54.

The TPIR detector 56 includes appropriate monitoring, light source, gas cell and microprocessor components in the detector module 60 within the housing, with such components being operatively associated with an audible alarm 64, such alarm being actuated when the detector module 60 detects an incursion of refrigerant vapor into the interior volume of the detector 56. The components of the TPIR detector are energized by a power cord 62 that is integrated with the power cord for the refrigerator 50, to supply power from a conventional electrical outlet.

As another application of the invention, fruits and vegetables in storage areas or as imported from different areas of the world require fumigation to remove living organisms that could damage the produce or lead to widespread infestation in the destination country. Such fumigation, for a wide variety of fruits and vegetables, involves the use of bromomethane (BrMe), a global warming gas. The invention contemplates the use of a TPIR device to monitor the bromomethane in such application. For example, the TPIR device can be used inside a fumigation chamber to measure or control the dosage of the BrMe. A TPIR device can also be used in-line in a gas flow path of the bromomethane, to measure the concentration of such gas either upstream or downstream of an abatement device.

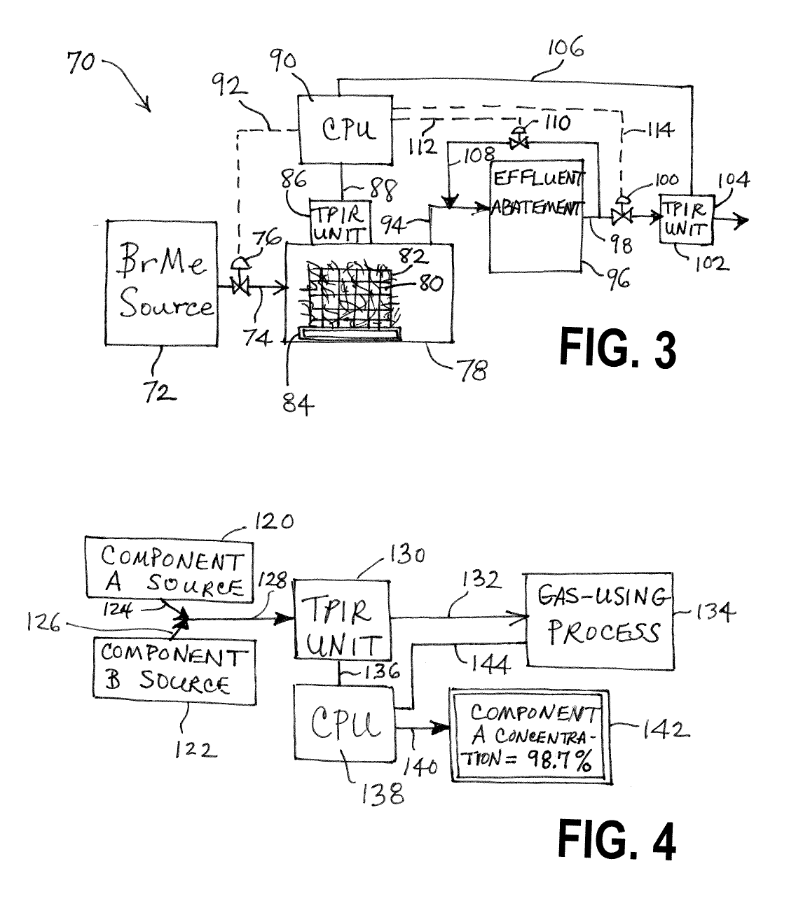

FIG. 3 is a schematic representation of a fumigation treatment facility for fruits and vegetables, involving the use of BrMe. The fumigation system 70 includes a BrMe source 72 for dispensing the fumigant gas through line 74, containing flow control valve 76 therein, to fumigation chamber 78.

The fumigation chamber 78 defines an interior volume in which is positioned a container 82 of produce 80 disposed on pallet 84. The fumigant gas subsequent to contact with the produce 80 is discharged from the fumigation chamber in line 94 and flows to effluent abatement unit 96. The effluent abatement unit 96 may comprise any suitable treatment equipment and capability, for treatment of the fumigant gas to produce an effluent that is purified. The purified effluent flows in line 98, containing flow control valve 100 therein, to the TPIR unit 102. From TPIR unit 102, the effluent is discharged in line 104 to the ambient environment, or other disposition.

A TPIR unit 86 is also associated with the fumigation chamber 78, to monitor the fumigant gas in the interior volume of the chamber. The TPIR unit 86 generates a concentration sensing signal that is transmitted in signal transmission line 88 to the central processing unit 90. The CPU 90 also is coupled in signal transmission relationship, by signal transmission line 106, to the TPIR unit 102.

The effluent from the effluent abatement unit 96, once entering line 98, can be diverted in recycle line 108 to the inlet of the effluent abatement unit. The CPU 90 is coupled with the various flow control valves 76, 110 and 100 in the system. Valve 110 is disposed in recycle line 108.

In operation, the TPIR unit 86 senses the concentration of the BrMe gas in the fumigation chamber 78 and transmits a corresponding concentration signal in line 88 to CPU 90. The second TPIR unit 102 monitors the effluent from the effluent abatement unit 96, and correspondingly transmits a signal in signal transmission line 106 to the CPU.

The CPU thereby can operate to modulate the flow of fumigant gas to the produce in fumigation chamber 78, and/or can divert the effluent from the effluent abatement unit from discharge line 98 into recycled line 108, in the event that the effluent loading exceeds the capability of the specific effluent abatement unit.

In yet another implementation, the TPIR device is used for gas monitoring applications, in which the global warming gas is used as a trace material in mixture with a main constituent to the monitored, to indirectly measure the concentration of the main constituent, by monitoring the concentration of the global warming gas trace component, and determining from such concentration of the global warming trace gas component, the concentration of the main constituent.

FIG. 4 is a schematic representation of a gas blending and utilization system, in which a main gas (component A) is supplied from source 120 through feed line 124 to a mixing conduit 128, in which the component A gas is mixed with minor component B gas from source 122 flowed in feed line 126 to the mixing conduit 128.

Subsequent to such blending, the blended gas mixture flows through the TPIR unit 130, for monitoring of the component B gas, which may for example comprise a global warming gas. Subsequent to monitoring by the TPIR unit 130, the monitored gas is flowed in line 132 to a gas-using process 134. The TPIR unit 130 in the concentration sensing of component B gas generates a concentration sensing signal that is transmitted in signal transmission line 136 to CPU 138, which determines from the component B gas concentration the concentration of component A gas. The computationally determined component A gas concentration then is outputted in signal output line 140 to display 142.

Concurrently, the CPU 138 in response to the concentration determination of the component A gas may transmit a control signal in control signal transmission line 144 to the gas-using process 134, for modulation thereof, so that the gas-using process is thereby accommodated to the specific concentration of component A gas entering such process.

The invention in another aspect addresses the problem that the use of traditional infrared techniques in gas detection is limited by equipment cost and size consideration. The large size and mechanical complexity (e.g., involving the use of movable mirrors), and expensive and complex application software required for operation, make traditional infrared detectors unsatisfactory for use.

The TPIR photometer detector of the invention is highly compact, and may for example have dimensions of 4″×4″×˜24″. The detector can be simply configured to include a set of thermopile detectors and other simple componentry, without necessity of motorized mirrors, thereby enabling a small and efficient detection unit. In such TPIR photometry, the detection limit is determined by the path length, i.e., the distance of a sampled gas through which infrared radiation is transmitted, and the increased path length correlates with increased sensitivity, albeit at the cost of increased signal error. Accordingly, there is a trade-off between the path length and overall size of the TPIR detector.

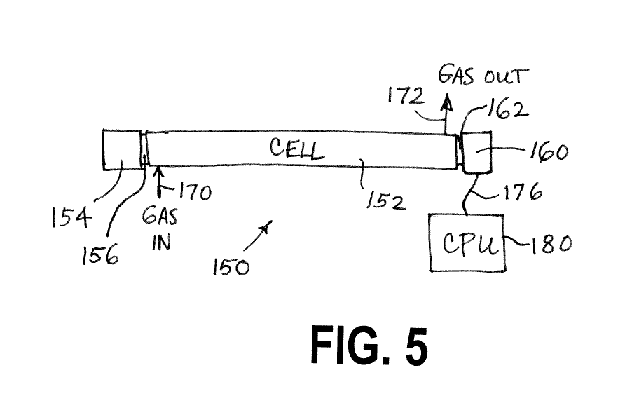

FIG. 5 is a schematic representation of a TPIR detector according to one embodiment of the invention. The TPIR detector 150 includes a monitoring cell 152 through which gas flows, as introduced in gas inlet 170 for flow through the cell to gas outlet 172. The TPIR detector includes an infrared radiation source 154 that is coupled via fiber optic cable and lens assembly 156 to the cell 152. The cell 152 in turn is coupled by fiber optic cable and lens assembly 162 to the sensor 160. The sensor 160 is coupled by signal transmission line 176 to the CPU 180, which algorithmically processes the signal received from the sensor 160 and generates an output indicative of the concentration of the monitor gas component in the gas flowed through the cell.

As shown in FIG. 5, the TPIR detector cell 152 is elongate form to maximize the path length within a compact overall conformation. “Elongate” in this context refers to a cell that preferably has a length to diameter (or cross-sectional width) of preferably at least 2, more preferably at least 5, are more preferably still at least 10.

The invention accommodates the competing considerations of path length and overall size, in a TPIR detector that uses fiber-optic components to transmit light signals, thereby enabling the size/detection limit characteristics of the detector to be markedly improved. Inasmuch as fiber-optic cable is an inherently efficient light carrier, it does not contribute significant signal noise in the operation of the detector. Accordingly, the TPIR detector can be of very small size, with detection limits as low as parts per billion.

The TPIR detector in such form can use a sample chamber that is divided into a number of zones, with each zone being equal to one pass through the sample chamber. By linking multiple zones together via fiber optic cable, low detection limits can be achieved with a very small detector unit. To prevent damage to the fiber optic cable, windows are preferably used at the interface of the cable and the sample chamber. Such windows can be made of any suitable material that provides satisfactory light transmission in the IR range. Specific materials of construction for such windows include, without limitation, calcium fluoride, potassium bromide, and the like. To enhance the focusing of the light, and to minimize loss of signal, lenses may be employed at selected locations to refocus the light beam. In addition, optical regenerators can be employed for boosting any loss of signal.

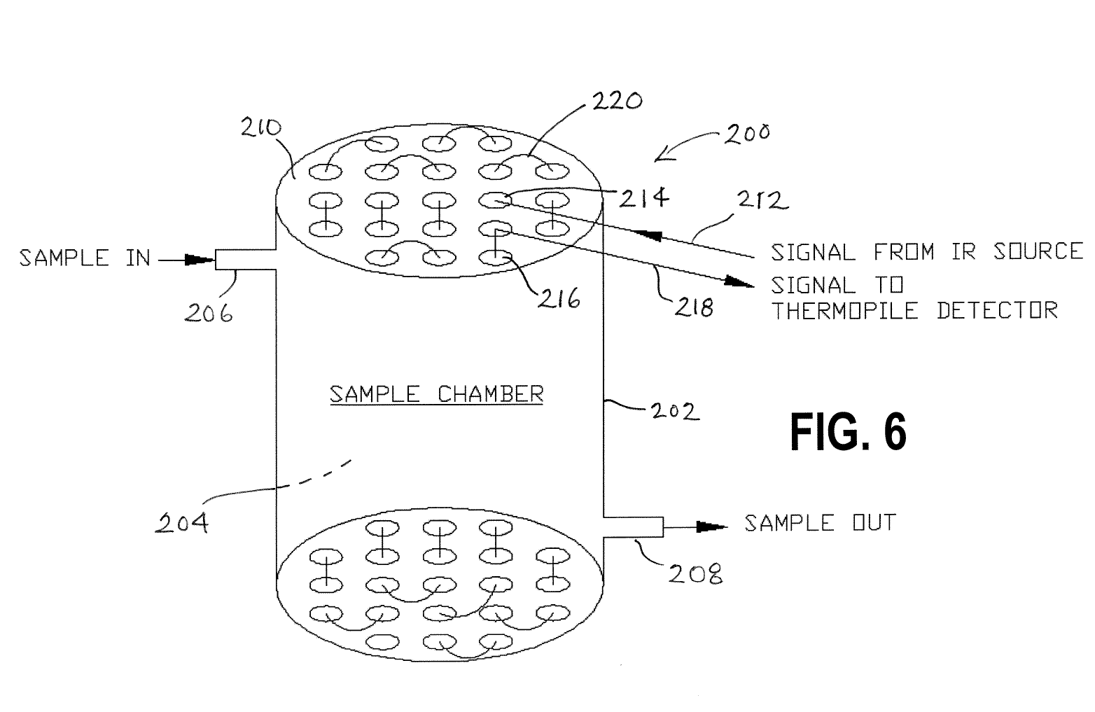

FIG. 6 is a schematic representation of a TPIR detector including a sample chamber 202 defining an enclosed interior volume 204 through which gas is flowed from inlet 206 to outlet 208. The detector inputs a signal from an infrared radiation source in fiber-optic input cable 212 to the window/lens 214 at the input face of the cell. The zones as shown are coupled by fiber-optic cables 220 to link the multiple zones together and achieve low detection limits. The output signal from lens 216 at the inlet/outlet face 210 of the sample chamber is passed in fiber-optic cable 218 to the thermopile detector sensing element.

The invention in another aspect addresses the problem that TPIR signals are typically very small compared to noise and temperature drifts (50 μV over a 10° C. range). In order to improve the signal to noise ratio while minimizing the calibration and complexity of the system, the light source is modulated, e.g., using a chopper wheel, occulting disc, or repetitive switching of the IR source in an on/off mode. By modulating the light source, a base line can be measured “in the dark,” enabling temperature-related offsets to be compensated. In addition, more sophisticated algorithms can be used to filter out unwanted noise in other frequency domains, to improve signal resolution, such as, for example, lock-in amplifier algorithms, least squares curve fitting to a known sine wave frequency, and other digital filter frequency response signal conditioning techniques, such as Finite Impulse Response (FIR) Fast Fourier Transform (FFT), and infinite impulse response (IIR) techniques.

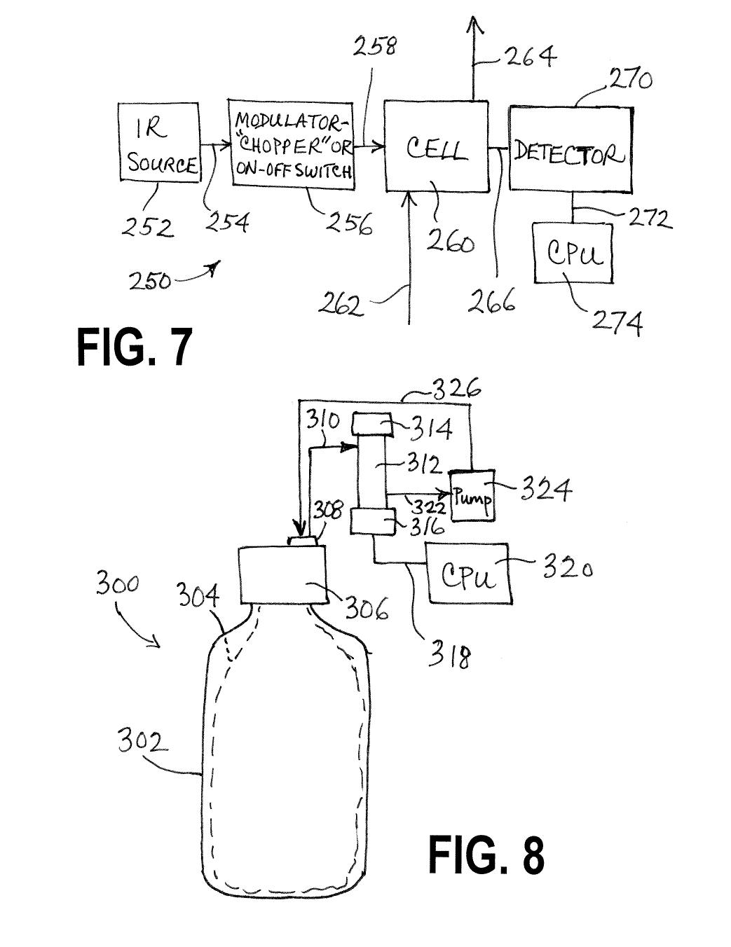

FIG. 7 is a schematic representation of a TPIR system utilizing such light source modulation. The system 250 includes IR source 252 generating an input light signal 254 that is processed by the modulator 256 to form a modulated light signal 258 that is passed to cell 260 through which the gas to be monitored is flowed, from inlet 262 to outlet 264.

The resulting light signal from the cell 266 is passed to the detector 270, which responsively generates an output signal indicative of the concentration, as passed in signal transmission line 272 to the CPU 274.

The modulator 256 may as described above comprise a chopper wheel, occulting disk or on/off switching to provide the desired modulation.

In another aspect, the invention addresses the problem of reliability of coupling of chemical reagent supply packages and dispense connectors that are coupled with the supply packages for dispensing of the chemical reagent from the supply package. One such chemical reagent supply package is commercially available under the trademark NOWPAK from ATMI, Inc. (Danbury, Conn., USA), and includes a rigid container in which is disposed a sterile polymeric liner. The liner holds the chemical reagent and the container is arranged for coupling with a dispense connector, so that liquid can be withdrawn from the liner by the dispense connector and flowed to a downstream chemical reagent-utilizing system, e.g., via interposed flow circuitry.

The chemical reagent supply container may be equipped with a cap that is keyed with certain keying elements that interfit with complementary keying structure on the dispense connector to ensure proper connection of the dispense connector and container. Alternatively, the cap may include an RFID tag that is coupleable in signal transmission relationship with a dispense connector equipped with a radio frequency antenna, so that information in the RFID element can be read and transmitted via the RF antenna to ensure proper coupling of the cap and dispense connector. This RFID-equipped package is commercially available from ATMI, Inc. (Danbury, Conn., USA) under the trademark NOWTRAK.

The NOWPAK and NOWTRAK packaging solutions represent approaches that are capable of preventing misconnects if the package and dispense connector are coded correctly. These approaches, however, do not actually identify the material that is contained in the supply package. Accordingly, even though the container and the dispense connector are matably engaged based on the coding of these respective parts of the package, the presence of a wrong chemical reagent in the container can cause the wrong material to be dispensed.

This in turn can result in the manufacture of products that are defective or even useless, due to the wrong material being supplied from the container.

Such problems are overcome in accordance with another aspect of the invention that provides active misconnection protection. According to this aspect, a measurement of the liquid is made that positively identifies the liquid. This technique provides a high degree of reliability in avoiding misconnection issues. As an example of this approach, a single multi-channel IR spectrometer could be used to fingerprint the liquid. In a preferred embodiment, a TPIR detector is employed for such purpose, thereby providing a simple and effective approach to determination of the contents of the storage and dispensing package.

In another embodiment, a viscosity measurement can be made, to positively identify the contained liquid.

These approaches may be implemented in a simple and effective manner, which could for example involve generation of a “pass” or “ok” signal to indicate the positive identification of the liquid and its match to an intended storage and/or dispensing operation.

FIG. 8 is a schematic representation of a liner-based transport and dispensing package 300, comprising a rigid container 302 holding a flexible film liner 304 and holding a chemical reagent liquid. The package 300 includes a cap 306 featuring a sample port 308 thereon, as illustrated.

The liquid transport and dispensing package 300 is shown as being monitored for verification of identity of the liquid, by a TPIR detector-based verification system.

The verification system includes a TPIR cell 312 through which infrared radiation is passed from a source 314 associated with the cell, and the detector sensor 316 receives the resulting radiation and generates a sensing signal that is transmitted in transmission line 318 to the CPU 320. The cell receives a sample of the liquid in sample line 310 joined to the sampling port 308. The sampled liquid egresses from the cell 312 through line 322 and is pumped by pump 324 through the return line 326.

By the arrangement shown, the liquid from the liner 304 in container 302 can be sampled prior to coupling of the package with a dispensing assembly. Thus, the identity of the liquid may be verified, thereby preventing miscoupling of the vessel with a dispensing assembly and dispensing of the liquid to a process for which the liquid was not intended.

In another aspect, the invention utilizes an infrared gas detector in connection with a mini-environment such as a glove box isolator environment. The use of mini-environments such as glove boxes is commonplace for transferring materials in a controlled environment. In such applications, a controlled environment is necessary to protect the material from ambient air as well as to protect the operator engaged in the material transfer. Such controlled mini-environments are widely variable in their commercial implementations, but typically, such systems employ a catalyst bed to remove moisture and oxygen. Monitors are employed to continuously monitor the efficiency of the catalyst bed, and when the usefulness of the bed is depleted, the catalyst is regenerated, e.g., by heating and purging of the catalyst bed.

In these applications, involving a wide variety of materials that are used in such mini-environments, catalyst poisoning is a commonplace occurrence. In addition, such mini-environments are susceptible to cross-contamination of chemistries due to build-up of contaminant materials.

The invention addresses such problems by the provision of a thermopile infrared detector to monitor the mini-environment. For example, a sample can be extracted by a small pump or other extraction device, and delivered to a remote or externally located TPIR cell. Alternatively, the cell can be placed inside the mini-environment. To accommodate the chemistries specifically employed in a given mini-environment, the user can configure the TPIR correspondingly. For example, TPIR units may be configured to monitor three different gas species. Additional detectors may optionally be added, if necessary or desired.

Conventional controlled-environment systems being commercialized are adapted to monitor only oxygen and water. The detector of the invention therefore is highly advantageous as employed to prevent cross-contamination or to avoid catalyst poisoning, by monitoring the controlled-environment for species other than oxygen and water. The TPIR detector can be adapted, for example, to monitor for a solvent being used, such as benzene, to allow the user to determine the precise identity of the monitored environment.

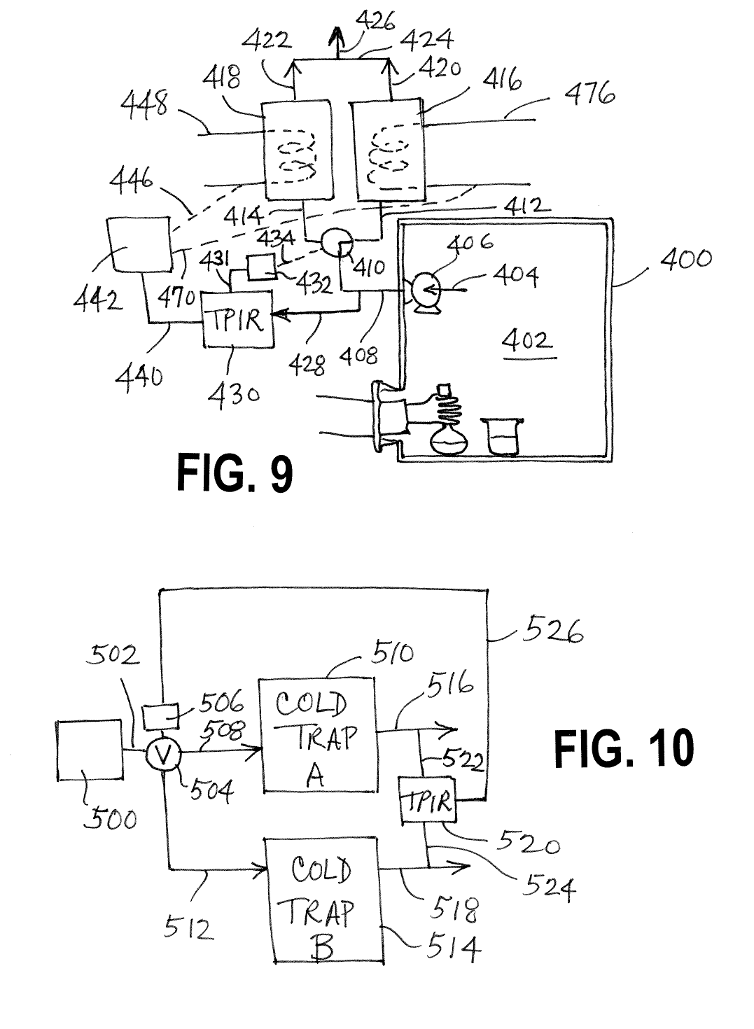

FIG. 9 is a schematic representation of a TPIR monitored mini-environment, in a glove box 400 enclosing an interior volume 402 in which a chemical reaction is being carried out by mixing of reactant reagents.

The glove box 400 has a pump 406 disposed in the interior volume 402, arranged with an intake 404 for discharging gas from the controlled environment of the glove box.

The pump 406 discharges to line 408 coupled with a two-way valve 410, such valve also being coupled with feed line 414. The valve is coupled by feed line 412 to catalyst bed 416 containing a catalyst material effective to remove contaminant species from the gas discharged from the glove box 400 by action of the pump 406. The catalyst bed 416 contains an embedded heat exchange coil 476 for regeneration of such catalyst bed.

The feed line 414 couples the two-way valve 410 with catalyst bed 418 having heat transfer coil 448 imbedded therein.

In this manner, gas discharged from the glove box in line 408 can be directed to a specific one of the respective catalyst beds 416 and 418, by appropriate positioning of the valve 410 to switch on one of the catalyst beds while switching off the other.

Catalyst bed 416 and 418 are provided with discharge lines 420 and 422, respectively, which join to a manifold line 424 from which treated effluent is discharged in vent line 426.

The gas discharged by pump 406 from the glove box is sampled in a side stream 428 by TPIR detector 430, which is operatively coupled to two-way valve controller 432 by signal transmission line 431. The controller 432 in turn is coupled by signal transmission line 434 to the valve 410. The TPIR detector 430 also is joined by signal transmission line 440 to controller 442, coupled in turn by signal transmission lines 446 and 470 to the respective regeneration systems including the respective embedded heat transfer coils 448 and 476.

By the arrangement shown, the TPIR monitor is arranged to detect the species in the gas discharged from the glove box, and to responsively direct the effluent to one of the two catalyst beds.

The TPIR detector 430 also receives sample gas from sample line 433 coupled to the discharge manifold 424, by which the efficacy of the on-stream catalyst bed is determinable by the TPIR detector. The TPIR detector responsively functions to send a control signal in signal transmission line 440 to the controller 442, to initiate regeneration of the catalyst bed when its capacity has been exhausted for removal of the contaminant species from the gas discharged from the glove box.

By this arrangement, the TPIR detector 430 controls the catalytic treatment of the glove box effluent and effects switching of the catalyst beds to maintain continuity of on-stream processing of the glove box effluent.

The invention in another aspect is employed to monitor an exhaust stream from a cold trap, to enable the trap to be cleaned and regenerated in a highly efficient manner, in order to maximize the effectiveness of the cold trap in on-stream operation, e.g., in a semiconductor manufacturing facility.

In semiconductor manufacturing processes that use or produce a byproduct species that tends to condense, e.g., phosphorus, aluminum trichloride, ammonium chloride, tungsten tetrafluorate, it is common to remove the byproduct species from the effluent stream prior to such byproduct species reaching the effluent abatement system, such as a scrubber. The condensable byproduct species in such instance are typically removed for use of a cold trap, which is configured for intimate contact of the effluent stream with a high surface area mesh, set of coils, or the like, as held at a reduced temperature compared to the effluent stream. The effluent stream then contacts the cold surfaces, to produce condensation of the condensable byproduct species. After a length of time and service, whose duration depends on the specific semiconductor manufacturing process and feed gas usage, the cold traps become severely loaded. As the cold surfaces become more progressively coated with condensed particulate byproduct material, the heat transfer efficiency of the trap decreases, with the frozen condensate forming a heat transfer barrier on the cold surface, thereby reducing the overall effectiveness of the trap.

As a result of such excessive freeze-out of the byproduct species on the cold surfaces, byproduct species that otherwise would have been removed by the cold trap then pass through the trap without capture, and flow to the further sections of the exhaust and abatement system, where such species may cause clogging or other severe effects detrimental to the effectiveness of the overall system.

The use of a TPIR detector for monitoring of the exhaust stream from the cold trap thereby permits a determination of when the effectiveness of trap is becoming significantly reduced. The endpoint of cold trap operation thereby is sensed, and permits the cold trap to be taken out of service, cleaned and regenerated for re-use, by an operator or an automatic regeneration system.

The use of a TPIR monitor for analysis of the exhaust of the cold trap takes advantage of the fact that condensable species captured by the cold trap tend to form a mist or aerosol in the carrier gas stream, and the TPIR monitor effectively senses such two-phase streams.

The TPIR monitor is positioned downstream of the cold trap and arranged with the cold trap exhaust flowing through the monitoring cell of the TPIR apparatus. When the trap begins to lose effectiveness, the level of condensable species remaining in the gas phase increases and such increased level of condensable species in the gas phase is sensed by the TPIR device and relayed as an output signal, e.g., a voltage change, to the associated computational module or other recordation device. The computational module or recorder device then can responsively generate a signal to actuate the regeneration sequence, whereby the trap is taken off-line, and submitted to regeneration, such as by flow of heated gas therethrough, or by simple ambient environmental exposure to cause evaporation of the frozen deposits, and their removal from the trap.

Alternatively, the voltage signal generated by the TPIR indicative of a predetermined loading of frozen condensate on the cold trap surfaces can be employed to directly actuate a regenerator or regeneration sequence. The cold trap for such purpose may be provided in tandem, as an array of multiple cold trap units, whereby the loaded cold trap having deposits of condensed byproduct species thereon is taken out of service, and a fresh cold trap is introduced into the on-line processing sequence.

Accordingly, the use of a TPIR monitor enables a trap to be changed by cleaning or redirection of the effluent stream to a parallel trap, before the levels of condensable species can create problems downstream of the trap in the subsequent flow circuitry or downstream process equipment (e.g., in an effluent abatement scrubber).

FIG. 10 is a schematic representation of a cold trap system, in which a source 500 of process gas is linked by line 502 to a flow control valve 504 joined in turn to feed lines 508 and 512 coupled with cold trap A 510 and cold trap B 514.

The cold traps feature effluent lines 516 and 518, respectively, that are linked by sample line 522 and 524 to a TPIR detector 520. In this manner, the TPIR unit samples the effluent from the on-stream one of the two cold traps 510 and 514. In response to such concentration monitoring, the TPIR generates an output signal that is transmitted in line 526 to the valve controller 506, when the on-stream one of the cold traps evidences a loaded status. The control signal thereupon causes the controller 506 to switch valve 504, so that a formerly on-stream cold trap is taken off-stream, and the other of the cold traps then is placed on-stream, for continuity of cold trap treatment operation.

By this arrangement, the cold traps continuously function to condense and freeze-out undesired containments from the gas supplied by source 500, so that the effluent is of a desired character and purity.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A gas monitoring system including a TPIR detector, operatively arranged for a sensing operation comprising any of:
(a) sensing of a multicomponent gas to determine a concentration of a component therein other than a component detectible by the TPIR detector;
(b) sensing of gas in a cell having a multiplicity of zones therein defined using fiber optic cables to provide a multiplicity of gas sensing paths within the cell;
(c) sensing with a modulated infrared radiation source switched in on/off cycles;
(d) sensing of a fluid sampled from a supply package to verify identity of fluid contained within said supply package;
(e) sensing of effluent from an environment after treatment to remove contaminants therefrom; and
(f) sensing of effluent from a cold trap system to determine when a cold trap has been loaded and requires regeneration.

2. The system of claim 1, operatively arranged for sensing of a multicomponent gas to determine a concentration of a component therein other than a component detectible by the TPIR detector.

3. The system of claim 1, operatively arranged for sensing of gas in a cell having a multiplicity of zones therein defined using fiber optic cables to provide a multiplicity of gas sensing paths within the cell.

4. The system of claim 1, operatively arranged for sensing with a modulated infrared radiation source switched in on/off cycles

5. The system of claim 1, operatively arranged for sensing of a fluid sampled from a supply package to verify identity of fluid contained within said supply package

6. The system of claim 1, operatively arranged for sensing of effluent from an environment after treatment to remove contaminants therefrom.

7. The system of claim 1, operatively arranged for sensing of effluent from a cold trap to determine when the cold trap has been loaded and requires regeneration.

8. The system of claim 1, wherein the gas comprises any of: a fluorocarbon, a chlorofluorocarbon, a halocarbon, a sulfur halide gas, nitrogen trifluoride, sulfur hexafluoride, and a refrigerant fluid.

9. The system of claim 1, wherein the TPIR detector includes an elongate cell.

10. The system of claim 1, further comprising an alarm adapted to output a user-perceptible signal indicative of attainment of a specified condition.

11. The system of claim 5, wherein the supply package comprises a liner-based supply package and the fluid contained therein comprises a microelectronic device manufacturing reagent.

12. The system of claim 6, wherein said environment comprises a glove box isolator environment.

13. The system of claim 1, operatively arranged for a sensing operation comprising at least two of elements (a)-(f).

14. A gas sensing process comprising use of a system according claim 1.

15. A method of gas sensing comprising any of:
(a) sensing of a multicomponent gas to determine a concentration of a component therein other than a component detectible by the TPIR detector;
(b) sensing of gas in a cell having a multiplicity of zones therein defined using fiber optic cables to provide a multiplicity of gas sensing paths within the cell;
(c) sensing with a modulated infrared radiation source switched in on/off cycles;
(d) sensing of a fluid for verification of identity thereof in a supply package containing such fluid;
(e) sensing of effluent from an environment after treatment to remove contaminants therefrom; and
(f) sensing of effluent from a cold trap system to determine when a cold trap has been loaded and requires regeneration,
wherein the sensing comprises thermopile detection of radiation in an infrared spectral regime.

16. The method of claim 15, comprising sensing of a multicomponent gas to determine a concentration of a component therein other than a component detectible by the TPIR detector.

17. The method of claim 15, comprising sensing of gas in a cell having a multiplicity of zones therein defined using fiber optic cables to provide a multiplicity of gas sensing paths within the cell.

18. The method of claim 15, comprising sensing with a modulated infrared radiation source switched in on/off cycles.

19. The method of claim 15, comprising sensing of a fluid for verification of identity thereof in a supply package containing such fluid.

20. The method of claim 15, comprising sensing of effluent from an environment after treatment to remove contaminants therefrom.

21. The method of claim 15, comprising sensing of effluent from a cold trap to determine when the cold trap has been loaded and requires regeneration.

22. The method of claim 15, wherein the sensed gas comprises any of: a fluorocarbon, a chlorofluorocarbon, a halocarbon, a sulfur halide gas, nitrogen trifluoride, sulfur hexafluoride, and a refrigerant fluid.

23. The method of claim 15, wherein the TPIR detector includes an elongate cell.

24. The method of claim 15, further comprising activating an alarm adapted to output a user-perceptible signal indicative of attainment of a specified condition.

25. The method of claim 19, wherein the supply package comprises a liner-based supply package and the fluid contained therein comprises a microelectronic device manufacturing reagent.

26. The method of claim 20, wherein said environment comprises a glove box isolator environment.

27. The method of claim 20, wherein said treatment to remove contaminants comprises use of a catalytic removal system comprising a first catalyst bed and a second catalyst bed, further comprising, responsive to said sensing, effecting switching between the first catalyst bed and the second catalyst bed trap when any of the first catalyst bed and the second catalyst bed requires regeneration.

28. The method of claim 27, further comprising initiating regeneration of any of the first catalyst bed and the second catalyst bed responsive to said sensing.

29. The method of claim 21, wherein the cold trap system comprises a first cold trap and a second cold trap, further comprising, responsive to said sensing, effecting switching between the first cold trap and the second cold trap when any of the first cold trap and the second cold trap has been loaded and requires regeneration.

30. The method of claim 29, further comprising initiating regeneration of any of the first cold trap and the second cold trap responsive to said sensing.

31. The method of claim 15, further comprising wireless communication of a signal correlative of a thermopile detector output.

32. The method of claim 1, comprising sensing at least two of elements (a)-(f).
